(19) United States
(12) Patent Application Publication
(10) Pub. No.: US 2017/0161672 A1
(43) Pub. Date: Jun. 8, 2017

(54) CONSOLIDATED DEFERRED FULFILLMENT WITH REDUCED SHIPPING RESOURCE CONSUMPTION

(71) Applicant: International Business Machines Corporation, Armonk, NY (US)

(72) Inventor: Arthur F. Crotty, North Reading, MA (US)

(21) Appl. No.: 14/960,044

(22) Filed: Dec. 4, 2015

(51) Int. Cl. G06Q 10/08; G06Q 30/02; G06Q 30/06

(52) U.S. Cl. CPC G06Q 10/083; G06Q 30/0635; G06Q 30/0222

(57) ABSTRACT

An option is provided to a user within a web-based purchasing interface, in association with merchandise selected during a current web-based shopping session, to purchase and defer shipping of the merchandise until an accumulation of purchased merchandise across multiple web-based shopping sessions reaches a configured shipping threshold. Upon detecting selection of the option to purchase and defer shipping, a payment is accepted to purchase the merchandise and shipping of the merchandise is deferred until additional purchased merchandise during at least one subsequent web-based shopping session results in the accumulation of purchased merchandise that reaches the configured shipping threshold. Upon detecting, during at least one subsequent web-based shopping session, that additional merchandise selected by the user if purchased results in the accumulation of purchased merchandise that reaches the configured shipping threshold, a payment is accepted to purchase the additional merchandise and the accumulation of purchased merchandise is shipped to the user.

### BACKGROUND

The present invention relates to reducing resources used to ship and transport goods. More particularly, the present invention relates to consolidated deferred fulfillment with reduced shipping resource consumption.

Consumers may utilize the Internet to shop for and purchase goods. Consumers may also drive to brick and mortar stores to shop for and purchase goods.

### SUMMARY

A computer-implemented method includes providing, by a processor within a web-based purchasing interface in association with merchandise selected by a user during a current web-based shopping session, an option to the user to purchase and defer shipping of the merchandise until an accumulation of purchased merchandise across multiple web-based shopping sessions reaches a configured shipping threshold; responsive to detecting a user selection of the option to purchase and defer shipping of the merchandise, accepting a payment by the user to purchase the merchandise and deferring shipping of the merchandise to the user until additional purchased merchandise during at least one subsequent web-based shopping session results in the accumulation of purchased merchandise across the multiple web-based shopping sessions that reaches the configured shipping threshold; and responsive to detecting, during one of the at least one subsequent web-based shopping session, that additional merchandise selected by the user if purchased results in the accumulation of purchased merchandise across the multiple web-based shopping sessions that reaches the configured shipping threshold, accepting a payment by the user to purchase the additional merchandise and shipping the accumulation of purchased merchandise to the user.

A system that performs the computer-implemented method and a computer program product that causes a computer to perform the computer-implemented method are also described.

### BRIEF DESCRIPTION OF THE DRAWINGS

FIG. 1 is a block diagram of an example of an implementation of a system for consolidated deferred fulfillment with reduced shipping resource consumption according to an embodiment of the present subject matter;

FIG. 2 is a block diagram of an example of an implementation of a core processing module capable of performing consolidated deferred fulfillment with reduced shipping resource consumption according to an embodiment of the present subject matter;

FIG. 3 is a flow chart of an example of an implementation of a process for consolidated deferred fulfillment with reduced shipping resource consumption according to an embodiment of the present subject matter;

FIG. 4 is a flow chart of an example of an implementation of a process for consolidated deferred fulfillment with reduced shipping resource consumption that includes additional processing across multiple web-based shopping sessions according to an embodiment of the present subject matter;

FIG. 5A is a first diagram of an example of an implementation of a user interface that provides consolidated deferred fulfillment with reduced shipping resource consumption according to an embodiment of the present subject matter; and

FIG. 5B is a second diagram of an example of an implementation of a user interface that provides consolidated deferred fulfillment with reduced shipping resource consumption according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides consolidated deferred fulfillment with reduced shipping resource consumption. The present technology solves a recognized shipping-based natural resource and logistics-based resource usage problem by providing technology that includes a new form of computational processing within complex web-based transaction computing environments. The new technology described herein is configurable with shipping cost thresholds that operate to allow consumers to defer shipping, which may thereby reduce shipping resource usage (reduced natural resource usage and reduced logistics-based resource usage). Using the technology described herein, sellers may set a purchase threshold at which free shipping may be provided to consumers. The consumers may opt to complete their purchase(s), but defer shipping of their purchase(s) if their purchase(s) do not meet the purchase threshold. By providing consumer-selectable deferred shipping of completed purchases, the technology described herein provides multiple benefits that include reducing natural and logistics-based resource consumption, reducing pollution that results from shipping, and allowing consumers to take advantage of temporary price fluctuations (e.g., sales) without incurring shipping costs as long as the consumers are willing to wait for the purchased item(s) until they have accumulated enough purchases/total transaction amounts to qualify for free shipping. The technology described herein has an additional benefit of allowing consumers to make decisions regarding reduction of seller costs of shipping, which may further reduce consumer costs of items purchased in the future. Accordingly, natural resource usage, pollution, and departmental/shipping logistics-based resource usage for shipping and delivery of purchased items (e.g., number of packages in transit, number of vehicles used for delivery of purchased items) may all be reduced by use of the technology described herein.

It should be noted that shipping of purchased items consumes considerable natural resources, such as trees used to make cardboard shipping cartons, fossil fuels to deliver shipping cartons to sellers and to deliver packages of purchased items to consumers, and other forms of natural resources. Shipping of purchased items also consumes considerable logistic resources, such as personnel to manage shipping warehouses, to package/ship purchased items, and to deliver shipped items. The technology described herein provides a dual combined benefit of reducing the environmental shipping “footprint” (e.g., shipping resource consumption of and pollution of the environment) with user-selectable cost savings associated with shipping by reducing shipping carton count and transportation count. For purposes of the present description, the term “shipping resource” usage and “shipping resources” used includes both natural resources used in shipping and logistics-based resources used to package/deliver purchased items.

The technology described herein operates by providing, within a web-based purchasing interface in association with merchandise selected by a user during a current web-based shopping session, an option to the user to purchase and defer shipping of the merchandise until an accumulation of purchased merchandise across multiple web-based shopping sessions reaches a configured shipping threshold. In response to detecting a user selection of the option to purchase and defer shipping of the merchandise, a payment by the user to purchase the merchandise is accepted and shipping of the merchandise to the user is deferred until additional purchased merchandise during at least one subsequent web-based shopping session results in the accumulation of purchased merchandise across the multiple web-based shopping sessions that reaches the configured shipping threshold. Responsive to detecting, during one of the at least one subsequent web-based shopping session, that additional merchandise selected by the user if purchased results in the accumulation of purchased merchandise across the multiple web-based shopping sessions that reaches the configured shipping threshold, a payment by the user is accepted to purchase the additional merchandise and the accumulation of purchased merchandise is shipped to the user.

As such, one or more sellers of goods and/or fulfillment (shipping) centers may configure a purchase threshold that qualifies for free shipping. The purchase threshold may be established based upon a targeted reduction in shipping resources according to reduced shipping events.

A consumer may visit a purchasing website, may make one or more purchases over time, and may place the purchase(s) into a “shipping deferred status” until the configured purchase threshold that qualifies for free shipping is met or exceeded. As such, if the consumer is not currently interested in purchasing sufficient merchandise to reach the free shipping purchase threshold and does not currently wish to pay for shipping, the consumer may still complete the transaction and secure ownership of the purchased item(s). As the consumer continues to visit the purchasing website over time, the consumer may take advantage of new sales and may continue to place purchases and defer shipping until such a time that the accumulated purchases over time reach the purchase threshold for free shipping. In response to reaching or exceeding the purchase threshold for free shipping, the current purchase may trigger a customer notification that the purchase threshold for free shipping has been reached, and the consumer may be presented with an option to have all items shipped, including those with the shipping deferred status. In response to the consumer requesting that all items be shipped, a shipping action/event may be initiated within a fulfillment center to cause shipping of all items purchased and previously placed in the shipping deferred status. As such, shipping events may be reduced, with coincident reduction in shipping resource utilization.

The technology described herein may be provided on a website via one or more configurable user-selectable purchase options. One example implementation includes a single “Buy & Hold” button. The purchase may be placed into a holding account for the consumer and be retained on the retailer/fulfillment center warehouse shelf. The purchased items may remain in inventory at the fulfillment center, but may be flagged for pending shipment. It should be noted that the retailer/fulfillment center may have items in inventory already, and that no resources are expended to retrieve and package purchased items until enough items are purchased to reach the configured purchase threshold for free shipping. Again, once the configured purchase threshold for free shipping is reached for any consumer, the items on shipment hold and any new items purchased may be packaged and shipped to the consumer.

It should be noted that conception of the present subject matter resulted from recognition of certain limitations associated with shipping and transfer resource consumption. For example, it was observed that shipping and transfer of goods results in considerable shipping resource consumption within a shipping department (e.g., shipping cartons, shipping labels, packing and processing, etc.) and results in considerable transfer resource usage along transfer routes (e.g., natural resources such as trees used to make shipping cartons, and fossil fuels used in transit along roadways, railways, and airways, etc.). It was further observed that consumers are increasingly utilizing web-based transaction systems to search for and purchase goods, and that the increased use of web-based transaction systems on a conventional ship-per-transaction basis is also increasing shipping and transfer resource usage in proportion to the number of sales transactions. However, it was determined that this conventional granular ship-per-transaction approach to shipping wastes shipping and transfer resources and results in unnecessary pollution. It was additionally determined that consumers usually do not buy an item of interest found on a website if they have to pay for shipping, and that simultaneously the relative costs to sellers increases if they offer free shipping on low-cost items or at every transaction. It was determined as a result that shipping and transfer resources are not used efficiently by conventional ship-per-transaction processing used by conventional websites, and that new technology was desirable that reduces fossil fuel consumption and pollution, and that reduces costs associated with shipping and use of web-based transaction systems. It was further determined that if consumers were given a way to purchase items when they want to purchase them (e.g., on sale) and not have to drive to a brick and mortar store to do so or pay for shipping, the consumers may travel less to stores and thereby further reduce fossil fuel consumption. The present subject matter improves/reduces shipping and transfer resource consumption by providing for consolidated deferred fulfillment with reduced shipping resource consumption, as described above and in more detail below. As such, improved/reduced shipping and transfer resource consumption may be obtained through use of the present technology.

The consolidated deferred fulfillment with reduced shipping resource consumption described herein may be performed in real time to allow prompt arrangements for deferral of shipment and consolidation of multiple orders into a single shipment to reduce overall resources consumed during shipment. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

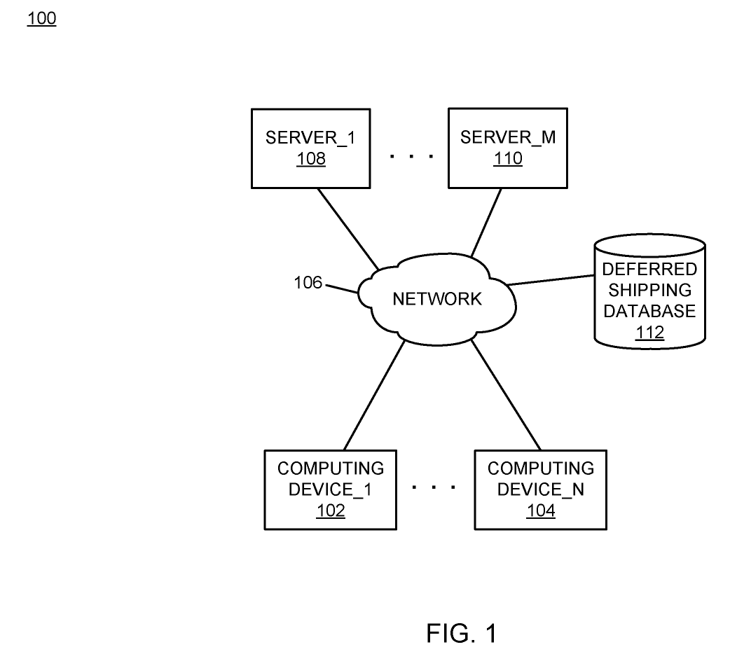

FIG. 1 is a block diagram of an example of an implementation of a system 100 for consolidated deferred fulfillment with reduced shipping resource consumption. A computing device_1 102 through a computing device_N 104 communicate via a network 106 with several other devices. The other devices include a server_1 108 through a server_M 110. A deferred shipping database 112 stores deferred purchases for consumers, and assists with providing the consolidated deferred fulfillment with reduced shipping resource consumption described herein.

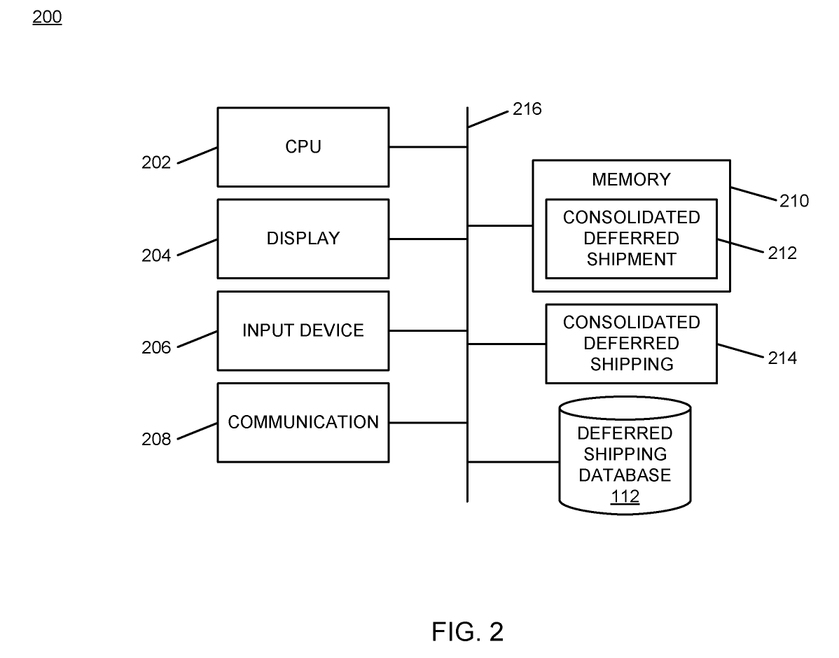

As will be described in more detail below in association with FIG. 2 through FIG. 5B, the computing device_1 102 through the computing device_N 104 may each provide automated consolidated deferred fulfillment with reduced shipping resource consumption. The automated consolidated deferred fulfillment with reduced shipping resource consumption is based upon conservation of shipping resources. As such, the present technology may be implemented at a user computing device or server device level, or by a combination of such devices as appropriate for a given implementation. A variety of possibilities exist for implementation of the present subject matter, and all such possibilities are considered within the scope of the present subject matter.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices.

The server_1 108 through the server_M 110 may include any device capable of providing data for consumption by a device, such as the computing device_1 102 through the computing device_N 104, via a network, such as the network 106. As such, the server_1 108 through the server_M 110 may each include a web server, application server, or other data server device capable of performing the consolidated deferred fulfillment with reduced shipping resource consumption as described herein.

The deferred shipping database 112 may include a relational database, an object database, or any other storage type of device. As such, the deferred shipping database 112 may be implemented as appropriate for a given implementation.

FIG. 2 is a block diagram of an example of an implementation of a core processing module 200 capable of performing consolidated deferred fulfillment with reduced shipping resource consumption. The core processing module 200 may be associated with either the computing device_1 102 through the computing device_N 104 or with the server_1 108 through the server_M 110, as appropriate for a given implementation. As such, the core processing module 200 is described generally herein, though it is understood that many variations on implementation of the components within the core processing module 200 are possible and all such variations are within the scope of the present subject matter. Further, the core processing module 200 may be implemented as an embedded processing device with circuitry designed specifically to perform the processing described herein as appropriate for a given implementation.

Further, the core processing module 200 may provide different and complementary processing of consolidated deferred fulfillment with reduced shipping resource consumption in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 (“processor”) provides hardware that performs computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, touchscreen, voice command processing unit, or any other type of input device by which the user may interact with and respond to information on the display 204.

It should be noted that the display 204 and the input device 206 may be optional components for the core processing module 200 for certain implementations/devices, or may be located remotely from the respective devices and hosted by another computing device that is in communication with the respective devices. Accordingly, the core processing module 200 may operate as a completely automated embedded device without direct user configurability or feedback. However, the core processing module 200 may also provide user feedback and configurability via the display 204 and the input device 206, respectively, as appropriate for a given implementation.

A communication module 208 provides hardware, protocol stack processing, and interconnection capabilities that allow the core processing module 200 to communicate with other modules within the system 100. The communication module 208 may include any electrical, protocol, and protocol conversion capabilities useable to provide interconnection capabilities, as appropriate for a given implementation. As such, the communication module 208 represents a communication device capable of carrying out communications with other devices.

A memory 210 includes a consolidated deferred shipment processing and storage area 212 that stores data related to deferred shipments within the core processing module 200. As will be described in more detail below, the data stored within the consolidated deferred shipment processing and storage area 212 is used to process purchases for deferred shipping and to later fulfill/deliver deferred purchases as described herein.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A consolidated deferred shipping module 214 is also illustrated. The consolidated deferred shipping module 214 provides processing capabilities that facilitate, track, and indicate that appropriate fulfillment criteria have been satisfied for consolidated deferred shipments within the core processing module 200, as described above and in more detail below. The consolidated deferred shipping module 214 implements the automated consolidated deferred fulfillment with reduced shipping resource consumption of the core processing module 200.

It should also be noted that the consolidated deferred shipping module 214 may form a portion of other circuitry described without departure from the scope of the present subject matter. The consolidated deferred shipping module 214 may form a portion of an interrupt service routine (ISR), a portion of an operating system, or a portion of an application without departure from the scope of the present subject matter. The consolidated deferred shipping module 214 may also include an embedded device with circuitry designed specifically to perform the processing described herein as appropriate for a given implementation.

The deferred shipping database 112 is again shown within FIG. 2 associated with the core processing module 200. As such, the deferred shipping database 112 may be operatively coupled to the core processing module 200 without use of network connectivity, as appropriate for a given implementation.

The CPU 202, the display 204, the input device 206, the communication module 208, the memory 210, the consolidated deferred shipping module 214, and the deferred shipping database 112 are interconnected via an interconnection 216. The interconnection 216 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. Many other possible arrangements for components of the core processing module 200 are possible and all are considered within the scope of the present subject matter. It should also be understood that, though the deferred shipping database 112 is illustrated as a separate component for purposes of example, the information stored within the deferred shipping database 112 may also/alternatively be stored within the memory 210 without departure from the scope of the present subject matter. Accordingly, the core processing module 200 may take many forms and may be associated with many platforms.

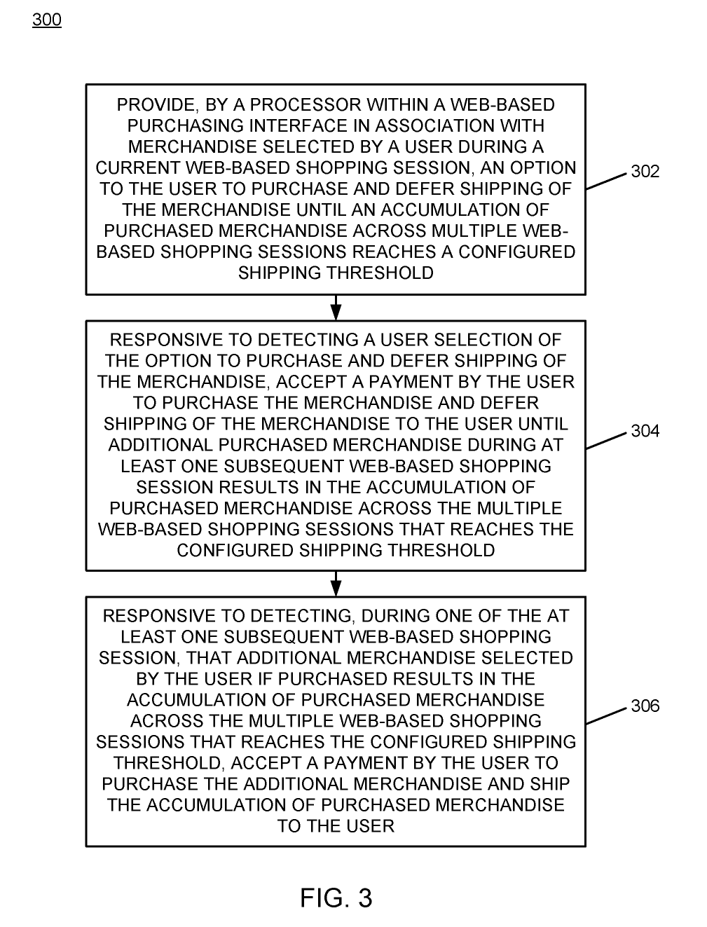

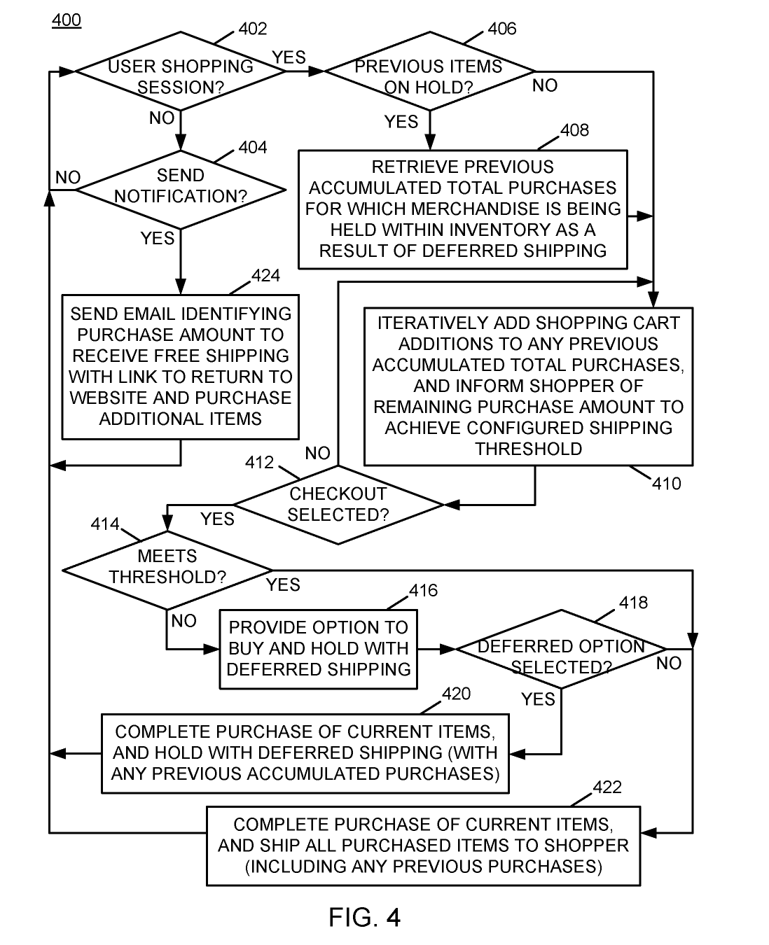

FIG. 3 through FIG. 4 described below represent example processes that may be executed by devices, such as the core processing module 200, to perform the automated consolidated deferred fulfillment with reduced shipping resource consumption associated with the present subject matter. Many other variations on the example processes are possible and all are considered within the scope of the present subject matter. The example processes may be performed by modules, such as the consolidated deferred shipping module 214 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 3 is a flow chart of an example of an implementation of a process 300 for consolidated deferred fulfillment with reduced shipping resource consumption. The process 300 represents a computer-implemented method of performing the subject matter described herein. At block 302, the process 300 provides, by a processor within a web-based purchasing interface in association with merchandise selected by a user during a current web-based shopping session, an option to the user to purchase and defer shipping of the merchandise until an accumulation of purchased merchandise across multiple web-based shopping sessions reaches a configured shipping threshold. At block 304, the process 300, responsive to detecting a user selection of the option to purchase and defer shipping of the merchandise, accepts a payment by the user to purchase the merchandise and defers shipping of the merchandise to the user until additional purchased merchandise during at least one subsequent web-based shopping session results in the accumulation of purchased merchandise across the multiple web-based shopping sessions that reaches the configured shipping threshold. At block 306, the process 300, responsive to detecting, during one of the at least one subsequent web-based shopping session, that additional merchandise selected by the user if purchased results in the accumulation of purchased merchandise across the multiple web-based shopping sessions that reaches the configured shipping threshold, accepts a payment by the user to purchase the additional merchandise and ships the accumulation of purchased merchandise to the user.

FIG. 4 is a flow chart of an example of an implementation of a process 400 for consolidated deferred fulfillment with reduced shipping resource consumption that includes additional processing across multiple web-based shopping sessions. The process 400 represents a computer-implemented method of performing the subject matter described herein. At decision point 402, the process 400 begins higher-level iterative processing by determining whether a user shopping session has been initiated with a web-based purchasing server via a web-based purchasing interface. Affirmative processing responsive to the determination at decision point 402 will be described further below to continue with description of the higher-level iterative processing. As such, in response to determining that a user shopping session has not been initiated with a web-based purchasing server via a web-based purchasing interface, the process 400 makes a determination at decision point 404 as to whether to send a notification to any previous web-based shopping session users that have purchased merchandise that is being held in inventory as the result of deferred shipping/delivery. Again, affirmative processing responsive to the determination at decision point 404 will be described further below to continue with description of the higher-level iterative processing. As such, in response to determining not to send a notification to any previous web-based shopping session users that have purchased merchandise that is being held in inventory as the result of deferred shipping/delivery, the process 400 returns to decision point 402 and iterates as described above.

Returning to the description of decision point 402, it should be noted that users may login to the web-based purchasing interface or enter a previous purchase confirmation number or other information to allow the process 400 to recognize the user and to correlate any purchases during the current web-based shopping session with any previously-completed purchases by the user during at least one previous web session for which the merchandise is being held within inventory as the result of deferred shipping. It should additionally be noted that, as described in more detail below, the user may navigate back to the web-based purchasing interface responsive to selection of a link (e.g., hypertext link) within a notification such as an electronic mail sent to the user to remind the user that the user has previously-completed purchases for which the merchandise is being held within inventory as the result of deferred delivery and to inform the user of any purchase amount to reach the configured/free shipping threshold.

As such, in response to determining at decision point 402 that a user shopping session has been initiated with a web-based purchasing server via a web-based purchasing interface, the process 400 makes a determination at decision point 406 as to whether the user has any previously-purchased merchandise being held within inventory as the result of deferred shipping from at least one previous web-based shopping session. As such, the process 400 determines, in association with an initiation of the current web-based shopping session, whether any merchandise previously-purchased by the user during at least one previous web-based shopping session is being held within inventory as the result of deferred shipping. In response to determining at decision point 406 that the user has at least one item of previously-purchased merchandise being held within inventory as the result of deferred shipping from at least one previous web-based shopping session, the process 400 retrieves all previous accumulated total purchases by the user during any previous web-based shopping sessions for which the merchandise is being held within the inventory as the result of the deferred shipping at block 408. These previous accumulated total purchases are alternatively termed “previously-completed accumulated total purchases.”

In response to retrieving all previous accumulated total purchases by the user during any previous web-based shopping sessions for which the merchandise is being held within the inventory as the result of the deferred shipping at block 408, or in response to determining at decision point 406 that the user does not have any previously-purchased merchandise being held within the inventory as the result of the deferred shipping from at least one previous web-based shopping session, the process 400 begins iterative processing within the current web-based shopping session at block 410. This iterative processing at block 410 includes iteratively adding shopping cart merchandise item additions to any previous accumulated total purchases by the user during any previous web-based shopping sessions, and iteratively informing the user of any remaining purchase amount to reach the configured shipping threshold. The configured shipping threshold may include an accumulated purchase amount across the multiple web-based shopping sessions that qualifies for free shipping.

At decision point 412, the process 400 makes a determination as to whether the user has selected an option to checkout and complete current purchases during the current web-based shopping session via the web-based purchasing interface. In response to determining that the user has not selected an option to checkout and complete current purchases during the current web-based shopping session, the process 400 returns to block 410 and iterates as described above.

In response to determining at decision point 412 that the user has selected an option to checkout and complete current purchases during the current web-based shopping session via the web-based purchasing interface, the process 400 makes a determination at decision point 414 as to whether the current merchandise selections in the shopping cart during the current web-based shopping session, when added to any previously-completed purchases from prior web-based shopping sessions for which merchandise is being held within inventory as a result of the deferred shipping, total to meet the configured free shipping threshold. Affirmative processing responsive to the determination at decision point 414 will be described further below to continue with description of a purchase with a deferred shipping option.

As such, in response to determining at decision point 414 that the current merchandise selections in the shopping cart during the current web-based shopping session, when added to any previously-completed purchases from prior web-based shopping sessions for which merchandise is being held within inventory as a result of the deferred shipping, do not total to meet the configured shipping threshold, the process 400, at block 416, provides an option to the user to purchase and defer shipping of the merchandise until an accumulation of purchased merchandise across multiple web-based shopping sessions reaches the configured free shipping threshold. The option may include a “Buy & Hold” feature of the web-based purchasing interface as otherwise described herein. As such, the process 400 may provide the option to the user during the current web-based shopping session in response to determining that the merchandise selected by the user during the current web-based shopping session, when added to previously-completed accumulated total purchases by the user during at least one previous web session for which merchandise is being held within inventory as a result of the deferred shipping, total less than the configured shipping threshold. Further, it is understood that the merchandise is in stock and available for delivery to the user at a time of providing the option to purchase and defer shipping of the merchandise to the user.

At decision point 418, the process 400 makes a determination as to whether a user selection of the option to purchase and defer shipping of the merchandise has been detected. In this case, the negative determination processing will be described in more detail below to continue with the affirmative processing path. As such, in response to determining that a user selection of the option to purchase and defer shipping of the merchandise has been detected at decision point 418, the process 400 completes the purchase of current items in the shopping cart during the current web-based shopping session and places these items on hold within the inventory as the result of deferred shipping, along with any previous accumulated purchases that are already on hold within the inventory as the result of deferred shipping, at block 420. The process 400 returns to decision point 402 and iterates as described above.

Returning to the description of decision points 414 and 418, in response to determining either that the current merchandise selections in the shopping cart during the current web-based shopping session, when added to any previously-completed purchases from prior web-based shopping sessions for which the merchandise is being held within the inventory as the result of the deferred shipping, total to meet the configured free shipping threshold at decision point 414, or in response to determining that a user selection of the option to purchase and defer shipping of the merchandise has not been detected at decision point 418, the process 400 completes the purchase of the current items in the shopping cart during the current web-based shopping session and ships all purchased items to the user including any previous accumulated purchases for which the merchandise is being held within the inventory as the result of the deferred shipping at block 422. The process 400 returns to decision point 402 and iterates as described above.

Returning to the description of decision point 404, it should be noted that sales of merchandise and time in storage may be relevant to the user of the web-based purchasing interface and/or the sellers. As such, notifications may be configured to be programmatically sent to users with previously-purchased merchandise that is being held within the inventory as the result of deferred shipping to incentivize the users to complete the transactions and take delivery of all purchased items. As such, the process 400 may provide a notification to the user of an additional purchase amount required to meet the configured shipping threshold responsive to deferring shipping of the merchandise to the user. The notification may be in the form of an electronic mail message that includes a link to the web-based purchasing interface that allows the user to start a new web-based shopping session and add newly-purchased items to any previously-completed accumulated total purchases by the user during at least one previous web session for which the merchandise is being held within the inventory as the result of deferred shipping. Notifications of sales and other information may also be provided in the notification to the user.

As such, in response to determining at decision point 404 to send a notification to any previous web-based shopping session users that have previously-purchased merchandise that is being held within the inventory as the result of deferred shipping, the process 400 sends the notification with the appropriate information to allow the respective user(s) to return to the web-based purchasing interface to purchase additional items to add to the previously-purchased merchandise in order to obtain free shipping at block 424. It is understood that user selection of a link within the notification electronic mail message may cause the browser of the user to navigate back to the web-based purchasing interface, which may then result in a new web-based shopping session detectable by decision point 402 and processing as described above. Responsive to sending the notification to the user at block 424, the process 400 returns to decision point 402 and iterates as described above.

As such, the process 400 provides programmatic processing to allow users to integrate and accumulate completed purchases across multiple web-based shopping sessions with deferred shipping, and to add to those purchases over time until a configured shipping threshold is reached. As described above, this configured shipping threshold and the consolidated deferred fulfillment with reduced shipping resource consumption described herein may help to reduce shipping resource consumption, and may help to reduce pollution.

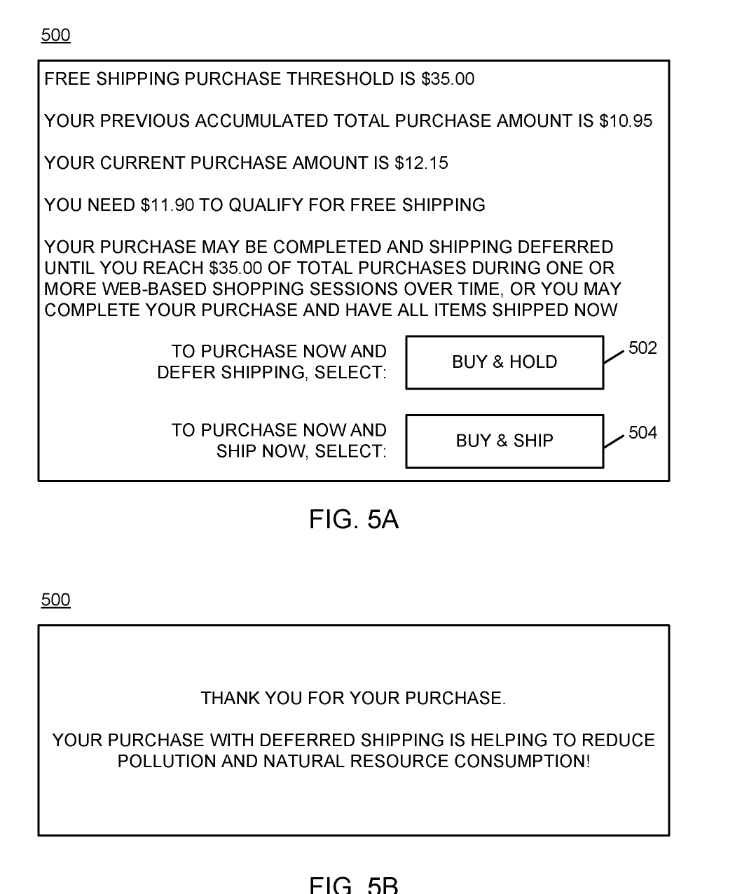

FIGS. 5A-5B illustrate example user interface displays that may be used in conjunction with consolidated deferred fulfillment with reduced shipping resource consumption as described herein. FIG. 5A illustrates a first diagram of an example implementation of a user interface 500 that provides consolidated deferred fulfillment with reduced shipping resource consumption. Within FIG. 5A, the user interface 500 provides a current status of items within a shopping cart of a web-based purchasing interface. As can be seen from FIG. 5A, a “Free Shipping Purchase Threshold” is set at thirty-five dollars ($35.00). The user's previous accumulated total purchase amount is ten dollars and ninety-five cents ($10.95) and the user's current purchase amount is twelve dollars and fifteen cents ($12.15). The user is informed that the user would need an additional eleven dollars and ninety cents ($11.90) in purchases within the current web-based shopping session or across multiple web-based shopping sessions to achieve the configured free shipping purchase threshold. The user is also informed that the user may complete the purchase and the purchased merchandise may be held in inventory for deferred shipping until the user reaches the configured free shipping purchase threshold of purchases during one or more subsequent web-based shopping sessions over time, or that the user may complete the purchase and have all items shipped now. The user is provided with an option 502 to complete the purchase and utilize deferred shipping. The user is also provided with an option 504 to complete the purchase and have the merchandise including all previous accumulated purchases shipped now. For purposes of the present example, it is presumed that the user selected the option 502 to complete the purchase and utilize deferred shipping. Intervening user interface processing to complete the purchase is omitted for brevity.

FIG. 5B illustrates a second diagram an example implementation of the user interface 500 that provides consolidated deferred fulfillment with reduced shipping resource consumption. Within FIG. 5B, the user is thanked for the purchase and is congratulated for helping to reduce pollution and natural resource consumption by use of the deferred shipping option.

As described above in association with FIG. 1 through FIG. 5B, the example systems and processes provide consolidated deferred fulfillment with reduced shipping resource consumption. Many other variations and additional activities associated with consolidated deferred fulfillment with reduced shipping resource consumption are possible and all are considered within the scope of the present subject matter.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art based upon the teachings herein without departing from the scope and spirit of the invention. The subject matter was described to explain the principles of the invention and the practical application, and to enable others of ordinary skill in the art to understand the invention for various embodiments with various modifications as are suited to the particular use contemplated.

What is claimed is:

1. A computer-implemented method, comprising:
providing, by a processor within a web-based purchasing interface in association with merchandise selected by a user during a current web-based shopping session, an option to the user to purchase and defer shipping of the merchandise until an accumulation of purchased merchandise across multiple web-based shopping sessions reaches a configured shipping threshold;
responsive to detecting a user selection of the option to purchase and defer shipping of the merchandise, accepting a payment by the user to purchase the merchandise and deferring shipping of the merchandise to the user until additional purchased merchandise during at least one subsequent web-based shopping session results in the accumulation of purchased merchandise across the multiple web-based shopping sessions that reaches the configured shipping threshold; and
responsive to detecting, during one of the at least one subsequent web-based shopping session, that additional merchandise selected by the user if purchased results in the accumulation of purchased merchandise across the multiple web-based shopping sessions that reaches the configured shipping threshold, accepting a payment by the user to purchase the additional merchandise and shipping the accumulation of purchased merchandise to the user.

2. The computer-implemented method of claim 1, further comprising:
determining, in association with an initiation of the current web-based shopping session, whether any merchandise previously-purchased by the user during at least one previous web-based shopping session is being held within inventory as a result of the deferred shipping;
retrieving all previously-completed accumulated total purchases by the user during the at least one previous web-based shopping session for which the merchandise is being held within the inventory as the result of the deferred shipping; and
iteratively adding shopping cart additions to the previously-completed accumulated total purchases and informing the user of any remaining purchase amount to reach the configured shipping threshold.

3. The computer-implemented method of claim 1, where providing, by the processor within the web-based purchasing interface in association with the merchandise selected by the user during the current web-based shopping session, the option to the user to purchase and defer shipping of the merchandise until the accumulation of purchased merchandise across multiple web-based shopping sessions reaches the configured shipping threshold comprises:
providing the option to the user during the current web-based shopping session in response to determining that the merchandise selected by the user during the current web-based shopping session, when added to previously-completed accumulated total purchases by the user during at least one previous web session for which merchandise is being held within inventory as a result of the deferred shipping, totals to less than the configured shipping threshold.

4. The computer-implemented method of claim 1, further comprising providing, responsive to deferring the shipping of the merchandise to the user, a notification to the user of an additional purchase amount required to meet the configured shipping threshold.

5. The computer-implemented method of claim 4, where the notification comprises an electronic mail message that comprises a link to the web-based purchasing interface that allows the user to start a new web-based shopping session and add newly-purchased items to any previously-completed accumulated total purchases by the user during at least one previous web session for which merchandise is being held in inventory as a result of the deferred shipping.

6. The computer-implemented method of claim 1, where the configured shipping threshold comprises an accumulated purchase amount across the multiple web-based shopping sessions that qualifies for free shipping.

7. The computer-implemented method of claim 1, where the merchandise is in stock and available for shipping to the user at a time of providing the option to the user to purchase and defer shipping of the merchandise.

8. A system, comprising:
a communication module; and
a processor programmed to:
provide, via the communication module within a web-based purchasing interface in association with merchandise selected by a user during a current web-based shopping session, an option to the user to purchase and defer shipping of the merchandise until an accumulation of purchased merchandise across multiple web-based shopping sessions reaches a configured shipping threshold;
responsive to detecting a user selection of the option to purchase and defer shipping of the merchandise, accept a payment by the user to purchase the merchandise and defer shipping of the merchandise to the user until additional purchased merchandise during at least one subsequent web-based shopping session results in the accumulation of purchased merchandise across the multiple web-based shopping sessions that reaches the configured shipping threshold; and
responsive to detecting, during one of the at least one subsequent web-based shopping session, that additional merchandise selected by the user if purchased results in the accumulation of purchased merchandise across the multiple web-based shopping sessions that reaches the configured shipping threshold, accept a payment by the user to purchase the additional merchandise and ship the accumulation of purchased merchandise to the user.

9. The system of claim 8, where the processor is further programmed to:
determine, in association with an initiation of the current web-based shopping session, whether any merchandise previously-purchased by the user during at least one previous web-based shopping session is being held within inventory as a result of the deferred shipping;
retrieve all previously-completed accumulated total purchases by the user during the at least one previous web-based shopping session for which the merchandise is being held within the inventory as the result of the deferred shipping; and
iteratively add shopping cart additions to the previously-completed accumulated total purchases and inform the user of any remaining purchase amount to reach the configured shipping threshold.

10. The system of claim 8, where, in being programmed to provide, via the communication module within the web-based purchasing interface in association with the merchandise selected by the user during the current web-based shopping session, the option to the user to purchase and defer shipping of the merchandise until the accumulation of purchased merchandise across multiple web-based shopping sessions reaches the configured shipping threshold, the processor is programmed to:
provide the option to the user during the current web-based shopping session in response to determining that the merchandise selected by the user during the current web-based shopping session, when added to previously-completed accumulated total purchases by the user during at least one previous web session for which merchandise is being held within inventory as a result of the deferred shipping, totals to less than the configured shipping threshold.

11. The system of claim 8, where the processor is further programmed to provide, responsive to deferring the shipping of the merchandise to the user, a notification to the user of an additional purchase amount required to meet the configured shipping threshold.

12. The system of claim 11, where the notification comprises an electronic mail message that comprises a link to the web-based purchasing interface that allows the user to start a new web-based shopping session and add newly-purchased items to any previously-completed accumulated total purchases by the user during at least one previous web session for which merchandise is being held in inventory as a result of the deferred shipping.

13. The system of claim 8, where the configured shipping threshold comprises an accumulated purchase amount across the multiple web-based shopping sessions that qualifies for free shipping.

14. A computer program product, comprising:
a computer readable storage medium having computer readable program code embodied therewith, where the computer readable storage medium is not a transitory signal per se and where the computer readable program code when executed on a computer causes the computer to:
provide, within a web-based purchasing interface in association with merchandise selected by a user during a current web-based shopping session, an option to the user to purchase and defer shipping of the merchandise until an accumulation of purchased merchandise across multiple web-based shopping sessions reaches a configured shipping threshold;
responsive to detecting a user selection of the option to purchase and defer shipping of the merchandise, accept a payment by the user to purchase the merchandise and defer shipping of the merchandise to the user until additional purchased merchandise during at least one subsequent web-based shopping session results in the accumulation of purchased merchandise across the multiple web-based shopping sessions that reaches the configured shipping threshold; and
responsive to detecting, during one of the at least one subsequent web-based shopping session, that additional merchandise selected by the user if purchased results in the accumulation of purchased merchandise across the multiple web-based shopping sessions that reaches the configured shipping threshold, accept a payment by the user to purchase the additional merchandise and ship the accumulation of purchased merchandise to the user.

15. The computer program product of claim 14, where the computer readable program code when executed on the computer further causes the computer to:
determine, in association with an initiation of the current web-based shopping session, whether any merchandise previously-purchased by the user during at least one previous web-based shopping session is being held within inventory as a result of the deferred shipping;
retrieve all previously-completed accumulated total purchases by the user during the at least one previous web-based shopping session for which the merchandise is being held within the inventory as the result of the deferred shipping; and
iteratively add shopping cart additions to the previously-completed accumulated total purchases and inform the user of any remaining purchase amount to reach the configured shipping threshold.

16. The computer program product of claim 14, where, in causing the computer to provide, within the web-based purchasing interface in association with the merchandise selected by the user during the current web-based shopping session, the option to the user to purchase and defer shipping of the merchandise until the accumulation of purchased merchandise across multiple web-based shopping sessions reaches the configured shipping threshold, the computer readable program code when executed on the computer causes the computer to:
provide the option to the user during the current web-based shopping session in response to determining that the merchandise selected by the user during the current web-based shopping session, when added to previously-completed accumulated total purchases by the user during at least one previous web session for which merchandise is being held within inventory as a result of the deferred shipping, totals to less than the configured shipping threshold.

17. The computer program product of claim 14, where the computer readable program code when executed on the computer further causes the computer to provide, responsive to deferring the shipping of the merchandise to the user, a notification to the user of an additional purchase amount required to meet the configured shipping threshold.

18. The computer program product of claim 17, where the notification comprises an electronic mail message that comprises a link to the web-based purchasing interface that allows the user to start a new web-based shopping session and add newly-purchased items to any previously-completed accumulated total purchases by the user during at least one previous web session for which merchandise is being held in inventory as a result of the deferred shipping.

19. The computer program product of claim 14, where the configured shipping threshold comprises an accumulated purchase amount across the multiple web-based shopping sessions that qualifies for free shipping.

20. The computer program product of claim 14, where the merchandise is in stock and available for shipping to the user at a time of providing the option to the user to purchase and defer shipping of the merchandise.
